(19) United States
(12) Patent Application Publication
(10) Pub. No.: US 2024/0399176 A1
(43) Pub. Date: Dec. 5, 2024

(54) Interchangeable Filter Systems for Respirators

(71) Applicant: Win-Shield Medical Devices Inc., Winnipeg (CA)

(72) Inventor: Robert Ranson, Winnipeg (CA)

(21) Appl. No.: 18/695,127

(22) PCT Filed: Sep. 22, 2022
(86) PCT No.: PCT/CA2022/051408

§ 371 Date: Mar. 25, 2024

Related U.S. Application Data
(60) Provisional application No. 63/247,477, filed on Sep. 23, 2021.

(51) Int. Cl. A62B 7/10; A62B 18/00; A62B 18/02; A62B 23/02

(52) U.S. Cl. CPC A62B 7/10; A62B 18/006; A62B 18/02; A62B 23/025

(57) ABSTRACT

An interchangeable filter system for a respirator, said system comprising a support frame, an air intake opening therein, a plurality of interchangeable filter holders each configured for selective mounting thereof to the support frame, and each configured to receive and hold a different respective type of air filtration device in a working position of operable relationship to said air intake opening to filter incoming ambient air, whereby the plurality of interchangeable filter holders enable customization of the system according to available on-hand inventory of one of more different types of air filtration devices. The system enables use of filter pads, cartridge filters and different styles of disposable air filtration facemasks as interchangeable air filtration devices on PAPR fan units, orinasal respirators and full-face respirators.

### CROSS-REFERENCE TO RELATED APPLICATIONS

This application claims benefit under 35 U.S.C. 119(e) of U.S. Provisional Application No. 63/247,477, filed Sep. 23, 2021, the entirety of which is incorporated herein by reference.

### FIELD OF THE INVENTION

This application relates generally to the field of personal protective equipment (PPE), and more particularly to respirators for supplying filtered, contaminant-free air to the wearer via a powered fan.

### BACKGROUND

The COVID-19 pandemic has demonstrated the vast importance of ensuring availability of adequate PPE to essential workers, and particularly to medical personnel who run the greatest risk of exposure, and whose collective wellbeing is critical in order to sustain sufficient healthcare coverage for the broader population. As a result, more than ever, there is a demand to novel solutions in the field of PPE that can at least partially mitigate recently faced challenges that arose during a combination of high-volume demand, inventory shortages, and supply chain disruption. Though the present invention was originally derived in this context of medical PPE for health care workers, the same inventive principles derived for such purpose can also be put to use any variety of other environments or industries where respirators are useful or required, including industrial applications, agricultural applications, pharmaceuticals, petro and other chemical applications, mining, metal fabrication, oil and gas, military, law enforcement, and firefighting.

### SUMMARY OF THE INVENTION

According to a first aspect of the invention, there is provided an interchangeable filter system for a respirator, said system comprising a support frame, an air intake opening therein, a plurality of interchangeable filter holders each configured for selective mounting thereof to the support frame, and each configured to receive and hold a different respective type of air filtration device in a working position of operable relationship to said air intake opening to filter incoming ambient air, whereby the plurality of interchangeable filter holders enable customization of the system according to available on-hand inventory of one of more different types of air filtration devices.

In one embodiment, said support frame and air intake opening are embodied in a fan unit of a powered air purifying respirator that comprises a fan operable to draw air through said intake opening and convey said air onwardly to a headspace fed by said powered air purifying respirator, whereby the plurality of interchangeable filter holders enable customization of the fan according to available on-hand inventory of one of more different types of air filtration devices.

In another embodiment, the support frame is embodied in a reusable face-worn respirator having at least one inhalation port therein at which the plurality of interchangeable filter holders are selectively and interchangeably couplable to the reusable face-worn respirator. The face-worn respirator may be an orinasal respirator for covering a partial area of a wearer's face over the mouth and nose thereof, or a full-face respirator with a face shield for covering an entirety of the wearer's face.

Preferably the different types of air filtration devices include at least any two, and in some instances all three, of the following: filter pads, air filtration facemasks and cartridge filters.

The air filtration facemasks may include a plurality of differently shaped facemask styles, for which there are respectively provided a plurality of differently configured facemask holders among the interchangeable filter holders.

There may be provide an addition holding component matable with the support frame and compatible with at least a subset of the interchangeable filter holders to hold a selected one thereof in place when mated to the support frame.

The holding component may comprise a holding collar matable with a collar support wall found on the support frame in surrounding relation to the air intake opening.

According to a second aspect of the invention, there is provided a respirator comprising:
a support frame having an air intake opening and a collar support of surrounding relationship to said air intake opening;
a holding collar configured for selective installation thereof on the collar support; and
at least one filter holder configured for held securement by said holding collar when installed on the collar support, and said filter holder also being configured to, in-turn, hold an air filtration device in a working position of operable relationship to said air intake opening to filter incoming ambient air.

According to a third aspect of the invention, there is provided a respirator comprising:
a support frame having an air intake opening; and
at least one filter holder that:
   is configured for selective mounting thereof to the support frame in a manner modifying an effective profile of the air intake opening; and
   is also configured to hold a separate air filtration device of conforming size and shape to the modified effective profile of the air intake opening.

Under either the second and third aspects of the invention, the respirator may be a powered air purifying respirator having a fan unit that embodies the support frame and the air intake opening, and that comprises a fan operable to draw air through said intake opening and convey said air onwardly to a headspace fed by said powered air purifying respirator.

Alternatively, the respirator may be a reusable face-worn respirator having an inhalation port therein at which the air intake opening is embodied.

According to a fourth aspect of the invention, there is provided a method of customizing a respirator according to availability among a plurality of different types of air filtration device, said method comprising:
on the basis of identified availability of a particular one of said different types of air filtration devices, modifying the respirator, from an initial state incompatible with said particular one of said different types of air filtration devices, by installing thereon a selected filter adapter that comprises a filter holder compatible with said particular one of said different types of air filtration devices.

### BRIEF DESCRIPTION OF THE DRAWINGS

Preferred embodiments of the invention will now be described in conjunction with the accompanying drawings in which:

FIG. 1 is a top perspective view of a fan support frame of an adaptable fan unit for a powered air-purifying respirator (PAPR), featuring an interchangeable filter system according to a first embodiment of the present invention.

FIG. 2 is a top/side perspective of the fan support frame FIG. 1 with an electric fan received thereon during assembly of the adaptable PAPR fan unit.

FIG. 3 is a top view of a holding collar mountable on a collar support wall of the fan support frame in a manner securing in place any selected one of a number of interchangeable filter holders.

FIG. 4 is a partial bottom perspective view of the holding collar of FIG. 3 illustrating an L-shaped slot therein for a bayonet-style coupling action between the holding collar and the collar support wall.

FIG. 5 shows a filter pad assembly composed of a filter pad sandwiched between a pair of perforated filter covers.

FIG. 6 shows a fully assembled PAPR fan unit using the filter pad assembly of FIG. 5.

FIG. 7 shows a two-piece facemask holder designed to hold a first style of disposable facemask thereon as an interchangeable substitute for the filter pad assembly of FIGS. 5 and 6.

FIG. 8 illustrates placement of the first style of facemask onto a rear gasket of the two-piece facemask holder of FIG. 7.

FIG. 9 illustrates the assembled facemask filter assembly using the two-piece facemask holder of FIGS. 7 and 8.

FIG. 10 shows a fully assembled PAPR fan unit featuring the facemask filter assembly of FIG. 9.

FIG. 11 shows another two-piece facemask holder designed to hold a second style of disposable facemask thereon as another interchangeable substitute for the filter pad assembly.

FIG. 12 illustrates how the facemask holder of FIG. 11 modifies the effective shape of the intake opening of the fan unit to conform with the profile shape of the second style of disposable facemask.

FIG. 13 shows a fully assembled PAPR fan unit using the facemask holder of FIG. 11.

FIG. 14 illustrates assembly of the PAPR unit using a cartridge holder defined to hold a cartridge filter as another interchangeable substitute for the filter pad assembly.

FIG. 15 shows a fully assembled PAPR fan unit using the cartridge holder of FIG. 14.

FIG. 16 is a front/side perspective view showing use of the fully assembled PAPR fan unit of FIG. 15 on a shoulder worn harness to feed filtered air to the internal headspace of a connected PAPR hood, thereby forming a complete PAPR system.

FIG. 17 is a rear/side perspective view of the PAPR system of FIG. 16.

FIG. 18 is an exploded perspective view showing one variant of the PAPR fan unit and filter pad assembly of FIGS. 5 and 6.

FIG. 19 is an exploded view illustrating a pair of filter pad assemblies of same or similar type to the one shown in FIG. 18, but in use with a non-powered orinasal respirator.

FIG. 20 is a front elevational view of the orinasal respirator of FIG. 19 with the filter pad assemblies fully installed thereon.

FIG. 21 is another front-elevational view of the orinasal respirator of FIGS. 19 and 20, but in exploded relation to a pair of facemask filter assemblies that are substitutable for the filter pad assemblies.

FIG. 22 is a front elevational view of the orinasal respirator of FIG. 21 with the facemask filter assemblies fully installed thereon.

FIG. 23 is an exploded perspective view of one of the facemask filter assemblies of FIGS. 21 and 22.

FIG. 24 is an exploded view of another facemask filter assembly substitutable for that of FIG. 23.

FIG. 25 is a front elevational view of a full-face respirator, illustrated in exploded relation to a pair of facemask filter assemblies of similar construction to those of FIGS. 21-24.

FIG. 26 shows the full-face respirator and facemask filter assemblies of FIG. 25 in an assembled state ready for use.

### DETAILED DESCRIPTION

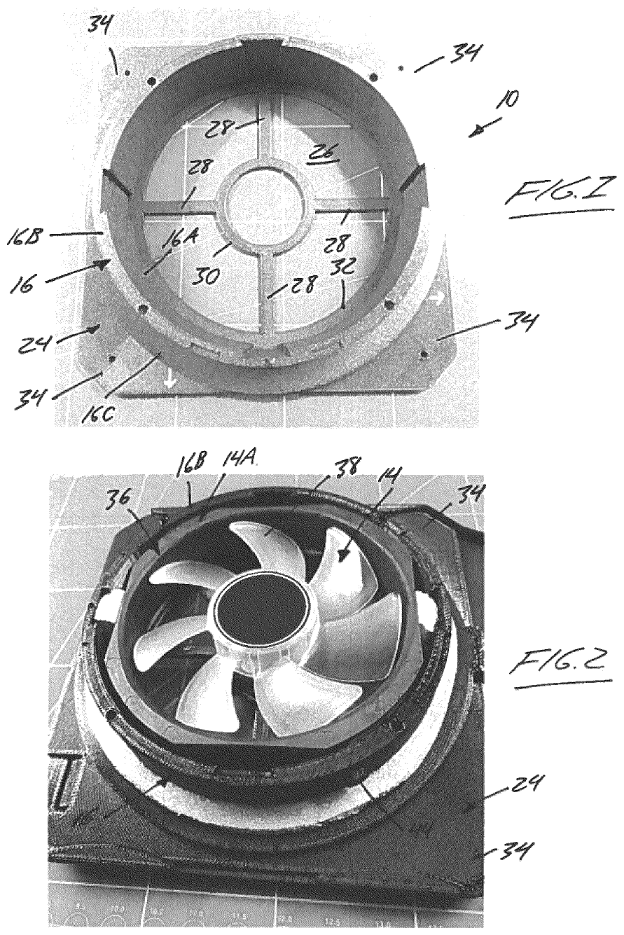

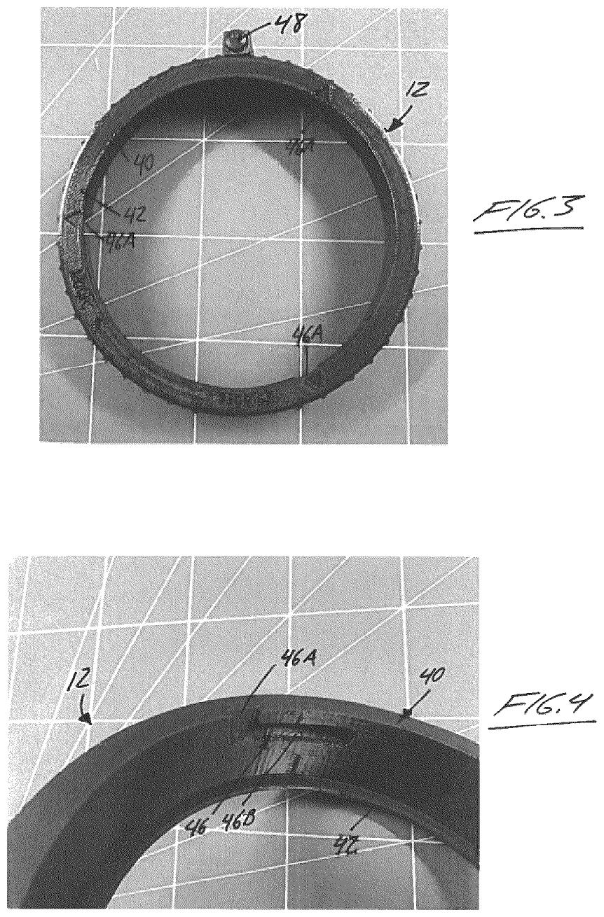

Disclosed herein with reference to FIGS. 1 to 17 is one embodiment of an interchangeable filter system by which the air intake of a PAPR fan unit can selectively be fitted with a number of different types of air filtration devices, for example including filter pads, disposable air filtration facemasks of various styles, and cartridge filters. As a result, a medical facility or other site requiring functional PAPRs for their personnel is not left underequipped by a local or widespread shortage of one particular type of air filtration device, and can make use of other air filtration devices that are already on-hand in their existing inventory, or are least more readily attainable from one or more well-stocked suppliers.

In the first embodiment shown in FIGS. 1 to 17, the invention is operably and reproducibly demonstrated in a form of a PAPR fan unit that comprises a fan support frame 10, an axial fan 14 receivable within the confines of an annular collar support wall 16 of the support frame, an accompanying holding collar 12 selectively mountable to the collar support wall 16, and a plurality of interchangeable filter holders 52, 58, 58′, 80 that are each selectively receivable on the fan support frame 10 and securable thereto by the holding collar 12 in a position holding a respective air filtration device (e.g. pad filter, disposable filtration facemask, or cartridge filter) in overlying and operational relation to the intake side of the fan 14. The support frame can be equipped with a wearable support garment (e.g. belt or shoulder harness), or be equipped with a clip or other connector for securement of the support frame to a support garment, for the purpose of worn support of the assembled fan unit 10 on the body of a user, who also wears an accompanying headpiece (hood, shield, mask, or combination thereof) to whose interior headspace the filtered air of the fan unit is routed, typically via a flexible hose leading from an outlet of the fan to a connection port in the headpiece. Alternatively, the support frame can include a clip or other connector configured for securement of the support frame to a supportive object or structure other than a worn garment, for example for attachment to a bed rail or other feature of a hospital bed or bed-adjacent structure or furniture, to feed filtered air to a fully or partially enclosed (e.g. tented) headspace occupied by the head of a bedded patient.

The support frame 10 is shown in isolation in FIG. 1, and features a flat base plate 24 having a circular opening 26 therein that defines an air outlet of the assembled PAPR fan unit through which filtered air is blown by the fan 14. In the illustrated example, this circular outlet opening 26 is not fully open, and instead features a set of radial spokes 28 spanning inwardly from the circular outer perimeter of the opening 26, and connecting to an annular center hub 30. The annular collar support wall 16 projects perpendicularly from the base plate 24 around the outer perimeter of the circular outlet opening 26, though at a short radial distance outward from the outlet opening, whereby an inner rim 32 of the base plate 24 juts inwardly from the interior surface 16A of the annular collar support wall 16 at the plane of the base plate 24. Outer peripheral regions 34 of the base plate 24 spans outwardly from the collar support wall 16, for example to provide suitable areas at which to mount the base plate 24 to a larger support structure that is in-turn attached to a belt or shoulder harness by which the fan unit is to be worn on the user's person, though optionally the base plate may instead be directly attached to such wearable belt or harness.

FIG. 2 illustrates receipt of the axial fan 14 in a nested position residing within the confines of the support frame's collar support wall 16, with an outer housing 36 of the axial fan seated against the inner rim 32 of the base plate with the output side of the fan 14 facing outwardly through the outlet opening 26 of the base plate 24. An axial depth of the fan housing 36 is similar to the axially projecting height of the collar support wall 16 from the plane of the base plate 24, whereby the opposing intake side 14A of the fan resides generally flush with an annular edge face 16B of the collar support wall 16 that resides oppositely of the base plate 24 and faces outwardly away therefrom. The collar support wall 16 delimits an air intake opening of the PAPR fan unit, though which ambient air is drawn by powered rotation of the fan blade 38 that is rotatably supported within the fan housing 36. The rotating fan blade 38 blows this drawn-in ambient air onwardly through the outlet opening 26 in the base 24 of the fan support frame 10.

The holding collar 12 features a cylindrical wall 40, and an in-turned flange 42 jutting inwardly from the cylindrical wall 40 at the top end thereof. The inner diameter of the cylindrical wall 40 slightly exceeds the outer diameter of the collar support wall 16 of the fan support frame 10 to enable external fitting of the holding collar's cylindrical wall 40 over the support frame's collar support wall 16. The inner diameter of the holding collar's in-turned flange 42 is less than the outer diameter of the support frame's collar support wall 16, so that when the holding collar 12 is fitted over the collar support wall 16, the in-turned flange 42 juts inwardly over the annular edge face 16B of the support wall 16. The outer surface 16C of the collar support wall 16 has a set of three externally protruding studs 44 thereon at discretely and evenly spaced positions around the support wall 16. One such stud 44 can be seen in FIGS. 2 and 12. The interior surface of the holding collar's cylindrical wall 40 features a set of three L-shaped slots 46 at spaced intervals around the cylindrical wall that match the interval spacing of the three studs 44 on the collar support wall 16. An axial leg 46A of each L-shaped slot 46 has an outer end that intersects the non-flanged annular end of the cylindrical wall 40, i.e. the end thereof opposite the in-turned flange 42. A circumferential leg 46B of each slot 46 extends in the circumferential direction of the cylindrical wall from the inner end of the axial slot furthest from the non-flanged end of the cylindrical wall 40. The studs 44 and slots 46 cooperate to enable a bayonet-style slide-and-turn coupling and securement action between the holding collar 12 and the collar support wall 16.

To install the holding collar 12 onto the collar support wall 16, and installer holds the holding collar 12 in a position aligning the axial legs 46A of the slots 46 with the studs 40, and axially slides the holding collar 12 onto the collar support wall 16. This axial sliding movement eventually bottoms out as a result of contact of the studs 44 with the inner ends of the axial slot legs 46A, whereafter the installer then rotates the collar around the shared axis of the collar and collar support wall until the studs 44 reach the far end of the circumferential slot legs 46B, which denotes a fully secured or locked condition of the holding collar on the collar support wall. Removal of the holding collar requires performance of the rotation and sliding action in reverse sequence and direction.

A coupling confirmation indicator 48 is included to provide automated confirmation of successful achievement of this secured/locked condition of the holding collar 12 on the collar support wall 16, which also signifies proper securement of one of the interchangeable filter holders when installed in cooperative relation with the holding collar 12, as described in more detail further below. In the illustrated embodiment, the indicator 48 is an LED mounted to the holding collar 12, and is wired to electrical contacts in one of the slots 46 that become electrically connected by corresponding electric contacts on the respective stud 44, which in turn are wired within an electric circuit with a power supply, preferably a shared power supply from which the fan 14 is also powered. Accordingly, secured/locked coupling of the holding collar 12 to the collar support wall 16 via the bayonet-style slide-and-turn action will close this circuit, and thereby activate the LED indicator 48 to signify proper user installation of a filter-holder, and rendering the PAPR fan unit ready for use.

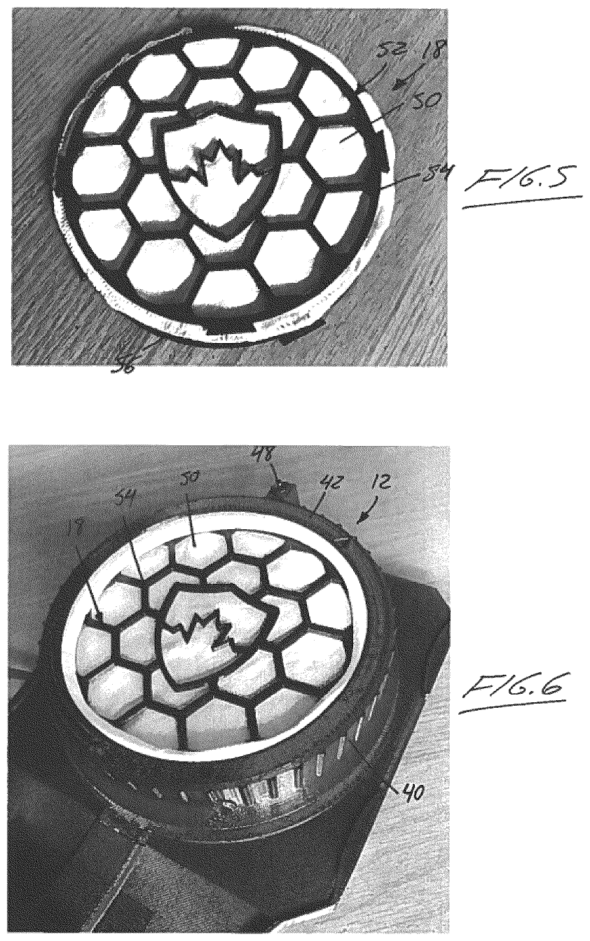

FIGS. 5 and 6 illustrate a first of a plurality of interchangeable filter assemblies that are each selectively securable to the fan support frame 10 using the holding collar 12. This first filter assembly 18 is a filter pad assembly that comprises a circular filter pad 50, and a two-piece pad holder 52 composed of a perforated front cover 54 and a perforated rear cover 56, between which the filter pad 50 is received in sandwiched relation thereto. In FIGS. 5 and 6, the front cover 54 is fully visible in front of the filter pad 50, while the rear cover 56 is substantially concealed therebehind. Each cover 54, 56 is substantially circular in outer perimeter. The filter pad 50 and both covers 54, 56 each have an outer diameter that exceeds the inner diameter of both the collar support wall 16 and the holding collar flange 42, but is less than the inner diameter of the holding collar's cylindrical wall 40. This way the covers 54, 56, and the filter pad 50 sandwiched therebetween, are receivable between the annular edge face 16B of the collar support wall 16 and the in-turned flange 42 of the holding collar 12 during placement of the holding collar 12, whereby the covers 54, 56, and the filter pad 50 are held firmly in clamped condition between the holding collar 12 and support wall 16.

So, to cooperatively install the holding collar 12 and the filter pad assembly 18, the installer places the filter pad 50 between the two perforated covers 54, 56 and places this sandwiched filter pad assembly into the holding collar 12 from the non-flanged end thereof to seat the perforated front cover 54 against the underside of the in-turned flange 42. The installer then engages the holding collar 12 onto the collar support wall 16 of the fan support frame 10 in the manner described above. The filter pad 50, and the front and rear covers 54, 56 respectively overlying the front and rear faces of the filter pad, are thereby securely clamped between the annular edge face 16B of the collar support wall 16 and the in-turned flange 42 of the holding collar 12. In this securely clamped position, the filter pad 50 is held in overlying and fully-covering relation to the air intake opening that leads into the intake side of the fan 14.

The perforated covers 54, 56 allow airflow through the filter pad 50, while retaining it securely in its installed plane, with the rear cover particularly holding the filter pad 50 fast against potential suction thereof into the fan. If the filter pad 50 itself has sufficient stiffness, the rear cover 56, or even possibly both of the perforated covers 54, 56, may optionally be omitted, with the filter pad 50 being used on its own, rather than being a subcomponent of a multi-component filter pad assembly 18. A branding logo may be incorporated into the web pattern of the perforated front cover 54, as demonstrated in the illustrated example, where a center area of the web pattern can be seen to embody a shield-like shape containing a maple leaf profile therein.

While the illustrated embodiment shows completely separable front and rear covers 54, 56 employed as a two-piece holder that securely houses a filter pad between them, and from between which the filter pad can be removed to enable cleaning/sterilization of the holder and substitution of a new filter pad between the newly cleaned/sterilized and reusable covers 54, 56, other embodiments may employ hinged-together covers as a single-piece clamshell-type holder from which used filter pads can likewise be removed to enable sterilization/cleaning of the covers and reuse thereof with a fresh filter pad. In other embodiments, separable or joined-together covers of a single-use disposable type may be used, for example as part of a prepackaged disposable product with a filter pad preloaded between the disposable covers.

The perforated covers 54, 56, whether separate components or hinged-together in clamshell fashion, thus form a filter holder insertable into the holding collar 12 to render same capable of holding a relatively flimsy filter pad in stable planar fashion over the intake side of the fan without risk of being drawn into the fan by the suction force thereof, thanks to the perforated rear cover. The perforated outer cover also provides a degree of protected shielding to the otherwise exposed front face of the filter pad. Additional and notable provision is also made of other additional filter holders, or adapters, that by adaptively modifying the air intake opening of the PAPR fan unit, render it also capable of using alternate types of generic air filtration devices in interchangeable fashion to the pad-filters that are specifically produced in compatible size to fit the PAPR fan unit. This way, the pad filters may be marketed and supplied as the default intended filtration means for the PAPR, yet in the event of a local or market-wide shortage of such pad filters due to unexpected inventory shortage or supply-chain disruptions, users of the PAPRs may turn to other more readily available filtration means to enable ongoing use of the PAPRs despite the lack of the default pad filters.

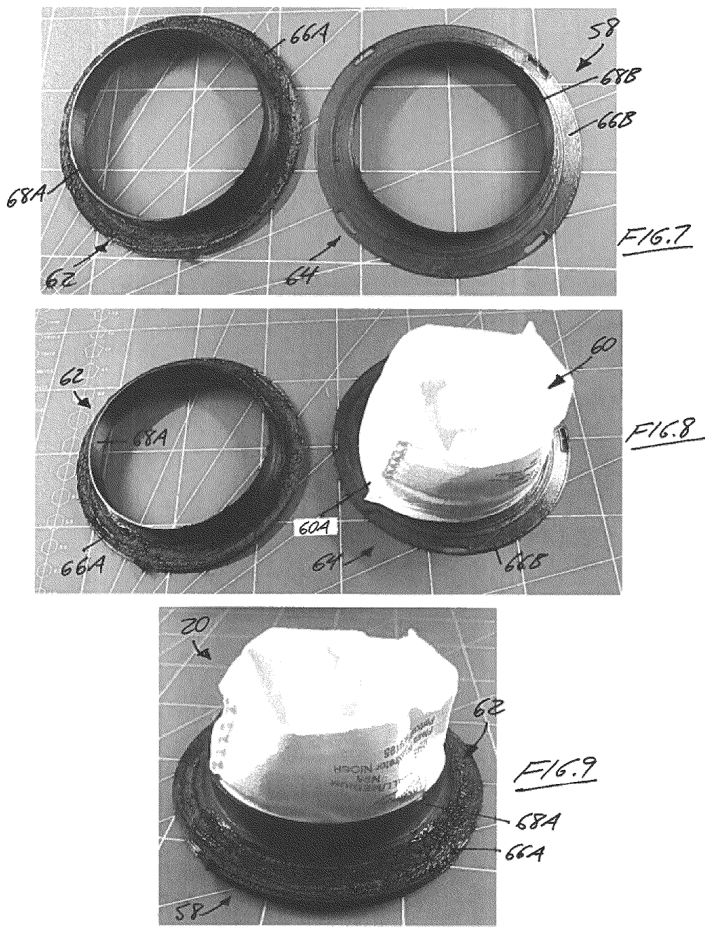

FIGS. 7 and 8 illustrate a second type of filter holder, in this instance a first facemask holder 58 designed for a first style of disposable facemask 60, which may for example be an N95 or KN95 disposable facemask. The illustrated example of this filter holder 58 once has a two-piece construction, in this case defined by front and rear annular gaskets 62, 64 designed to cooperatively fit together in a manner enclosing an outer peripheral region of the disposable facemask 60 between them. Each gasket 62, 64 has a generally planar outer rim 66A, 66B of circular outer perimeter, whose diameter exceeds the inner diameter of both the collar support wall 16 of the fan support frame 10 and the flange 42 of the holding collar 12, but is less than the inner diameter of the holding collar's cylindrical wall 40 so that the outer rims 66A, 66B of the two gaskets can be fitted and clamped between the support wall's annular edge face 16B and the underside of the holding collar flange 42, just like the outer peripheries of the front and rear covers 54, 56 of the pad holder. Each gasket 62, 64 also has an upturned inner rim 68A, 68B of round cylindrical form standing upward from the plane of the outer rim 66A, 66B at the inner perimeter thereof. To form a facemask filter assembly 20, an open side of the facemask 60 is fitted over the inner rim 68B of the rear gasket 64, as shown on the right side of FIG. 8, and then the front gasket 62 is slipped over the disposable facemask 60 and pushed into a mated position with the rear gasket 64. In this mated position, the backside of the front gasket's outer rim 66A abuts against the frontside of the rear gasket's outer rim 66B, and a peripheral edge region 60A of the disposable facemask's exterior is clamped between the upturned inner rims 68A, 68B of the two gaskets 62, 64.

The resulting facemask filter assembly 20 is shown in isolation in FIG. 9. Just as described above for the filter pad assembly 18, the facemask filter assembly 20 is inserted into the interior of the holding collar 12, in a mask-first orientation, into a seated position in which the frontside of the front collar's outer rim 66A abuts against the underside of the holding collar flange 42. In this position, the disposable facemask 60 secured between the two gaskets 62, 64 protrudes through the open center of the holding collar 12. The holding collar 12 is then installed onto the collar support wall 16 of the fan support frame 10 in the manner previously described above, thus clamping the outer rims 66A, 66B of the two gaskets 62, 64 in place between the support wall's annular edge face 16B and the underside of the holding collar flange 42. This installed position of the first facemask holder and its respective disposable facemask is shown in FIG. 10. The disposable facemask 60 is thereby secured in a position overlying the intake opening of the fan unit, and thus operable to filter the ambient air drawn into the fan during operation thereof. Accordingly, if a supply of filter pads 50 is unavailable, but disposable facemasks 60 are available, this facemask holder 20 can be used to assemble a fully functional PAPR using such a disposable facemask 60 as its air filtration device.

Numerous different styles of disposable facemasks are commercially available, and so the present invention may employ a multitude of facemask holders of respective compatibility with a variety of different facemask styles. The above-described facemask holder 20 shown in FIGS. 7 through 10 is compatible with a foldable/collapsible disposable facemask that, in preparation for use, is unfolded/expanded into a tent like form, the open side of which is then normally worn around the mouth and nostril area of a user and creates an enclosed tent-like air space between the mask and the user's face. In this expanded state, the open side of the particularly illustrated tent mask is generally circular, hence the use of cylindrical inner rims 68A, 68B on the two gaskets 62, 64 to capture a circular peripheral edge region 60A of the mask that spans around the circular opening of the mask.

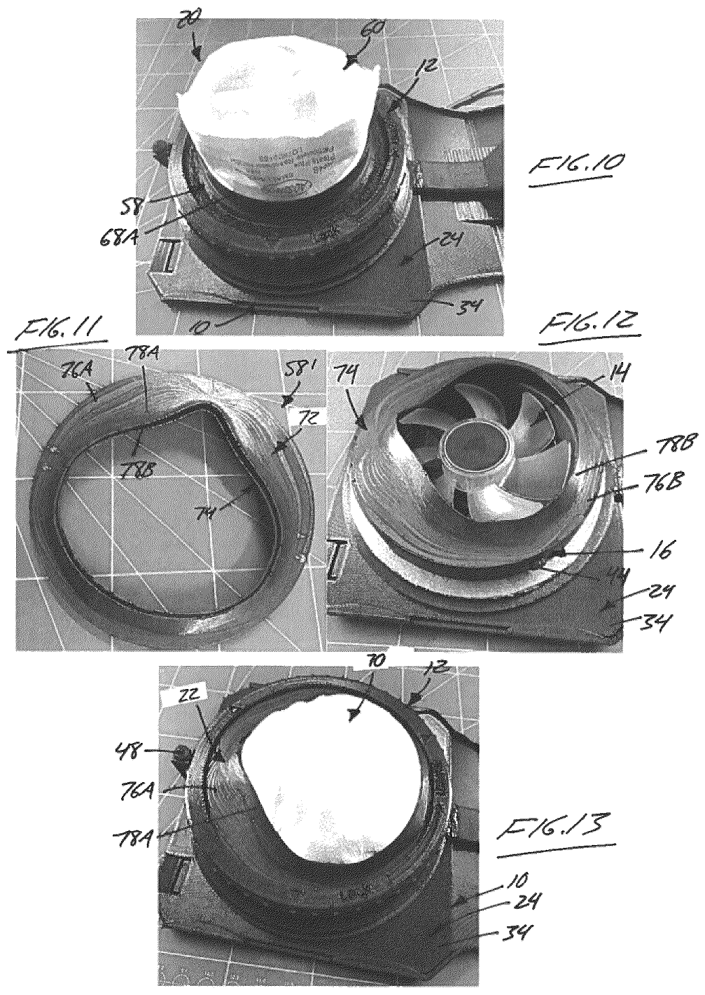

FIGS. 11 to 13 illustrate a second facemask holder 58′ designed for compatibility with a different style of disposable facemask 70, which again may be an N95 mask, in this being of a non-foldable/non-collapsible type that that retains a more stable, predetermined shape. The front/rear outer profile of this style of facemask 70 is more teardrop-shaped, with a rounded or ovular lower region delimiting a majority area of the mask that cover's the user's mouth, and a tapered upper region that grows narrower toward a rounded upper apex that is worn over the user's nose. The facemask holder 58′ for this teardrop shaped disposable facemask 70 once again features front and rear gaskets 72, 74. Each gasket 72, 74 once again has a generally planar outer rim 76A, 76B for clamped capture between the annular edge face 16B of the support frame's collar support wall 16 and the holding collar's in-turned flange 42. Each gasket 72, 74 once again also has upturned inner rim 78A, 78B of protruding relation from the plane of the generally flat outer rim 76A, 76B. However, whereas the inner rims 68A, 68B of the earlier facemask holder 58 were cylindrical in shape to provide a circular profile of substantially matching circular profile to the open side of the foldable/collapsible tent-style mask 60, the gaskets 72, 74 of this second facemask holder 58′ instead have inner rims 78A, 78B of teardrop-shaped profile. The inner rims 78A, 78B in this case are also of obliquely angled relationship to the planes of the outer rims 76A, 76B so that the open central areas of the gaskets delimited within the inner rims thereof grow smaller moving away from the planes of the outer rims. This angling of the inner rims 78A, 78B better conforms to the top and side profiles of the teardrop-style mask, where the width and height of the mask both decrease moving from the rear open side of the mask to the front of the mask.

The assembly and installation of a facemask filter assembly 22 using the second facemask holder 58′ is the same as described for the first facemask filter assembly 20, in that the open rear side of the disposable facemask 70 is fitted over the inner rim 78B of the rear gasket 74, the front gasket 72 is slid over the placed disposable facemask 70 into mated relation with the rear gasket 74, thus clamping a peripheral edge region of the mask 70 between the inner rims 78A, 78B of the two gaskets 72, 74, and the resulting assembly is then inserted mask-first into the holding collar 12. The holding collar 12 is then secured onto the collar support wall 16 of the fan support frame 10 to clamp the facemask filter assembly 22 in a position placing the disposable facemask 70 in a position overlying in the intake opening to filter the incoming ambient air drawn in by the fan's operation.

FIG. 12 shows, in isolation from the mask 70 and front gasket 72, the rear gasket 74 of the second facemask holder, particularly in the final working position in which the rear gasket 74 would reside when the entire filter assembly is installed. This figure demonstrates how the gaskets 72, 74, when so placed, form a shroud that changes the effective shape and size of the air intake opening of the PAPR fan unit, particularly so as to attain a modified shape of conforming profile and supportive relation to the open side of the mask 70 in question. As a result, the installed mask 70 covers the entirety of this holder-modified intake opening and can serve as an effective air filtration device for the PAPR fan unit, despite the mask having not been intentionally designed for such purpose.

The first facemask holder 58 performs the same function of adaptively modifying the effective size of the fan unit's intake opening to conformingly match and support the open side of that facemask holder's respective disposable facemask type 60, in this case not so much by changing the particular profile shape of the PAPR's default circular intake opening (as delimited by the cylindrical collar support wall 16), but rather serving to reduce the effective profile size of that circular opening to one better conforming the smaller circular opening of that facemask holder's respective disposable facemask type 60. While the figures illustrate only two examples of different facemask holders, it will be appreciated that a wide variety of facemask holder gaskets having inner rims of varying geometry may be produced to accommodate use of a wide variety of disposable facemasks of varying shape and size as effective filtration means for the PAPR fan unit. Just as described for the pad holder, though the facemask holders are illustrated in two-piece form with separate front and rear gaskets, the gaskets may again to hinged together to form a clamshell style holder to simplify the assembly of the holder and disposable facemask.

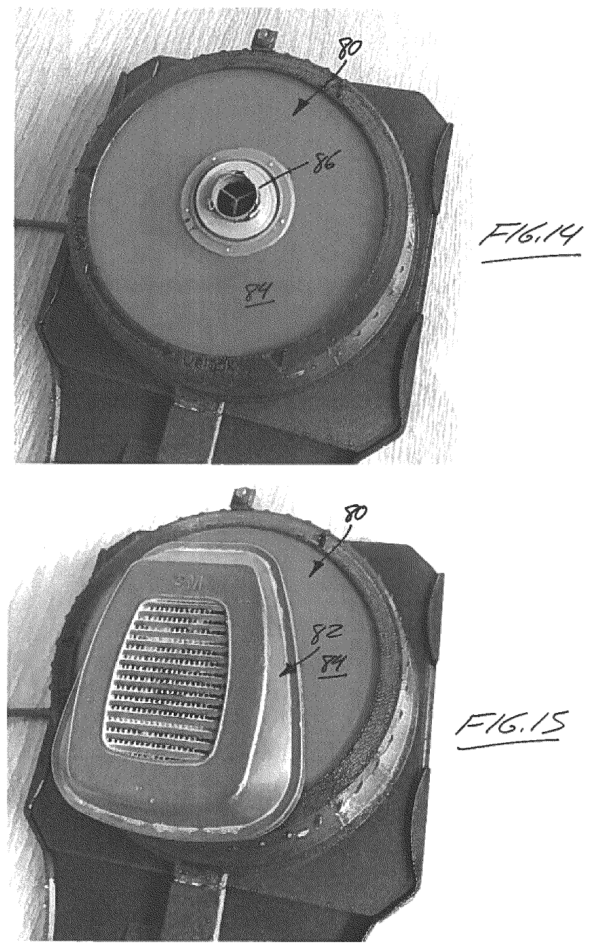

Turning to FIGS. 14 and 15, shown therein is yet another example of a holder that is interchangeable with the pad and facemask holders disclosed above, this time a cartridge holder 80 designed to convert the PAPR unit into a form suitable to use a cartridge filter 82 in place of the filter pads 50 or disposable facemasks 60, 70. The cartridge holder 80 features a round generally planar disk 84 whose circular outer perimeter is sized like those of the gaskets of the facemask holders 58, 58′ so that an outer peripheral region of the disk 82 can be clamped between the holding collar flange 42 and the collar support wall's annular edge face 16B, just like the rims of those facemask holder gaskets. At or nearer to a center of the disk 84, the cartridge holder 80 features a male bayonet connector 86 protruding from a front face of the disk around a hole that penetrates through the disk, whereby a conventional cartridge filter 82 with a female bayonet connector embodied therein is easily attachable to the disk 84 through a slide-and-turn bayonet-style coupling action.

Accordingly, the cartridge holder 80 is installed in similar fashion to the earlier holders, by inserting the disk 84 into the interior of the holding collar 16 in a connector-first orientation until the outer peripheral region of the disk's front face abuts the underside of the holding collar flange 42. In this seated position of the cartridge holder 80, the male bayonet connector 86 protrudes through the flange-delimited opening of the holding collar 12 to enable coupling of the cartridge filter 82 to the male bayonet connector 86, as shown in FIG. 15. Such coupling of the cartridge filter 82 may be performed before or after the holding collar 12 is engaged onto the collar support wall 16 of the fan support frame 10 in the manner described above. Such installation of the holding collar 12 and cartridge filter 82 secures the cartridge holder 80 and attached cartridge filter 82 in place in a working position operable to filter in the ambient air drawn into the fan 14 during operation thereof. The cartridge holder once again serves to adaptively modify the air intake opening of the PAPR fan unit to a conforming size to the respective air filtration device, this time covering a majority of the original air intake opening and leaving open only the much smaller bore of the male bayonet coupler 86 to feed into the fan 14.

While the illustrated example of the cartridge holder 80 features only one male bayonet connector 86 for receiving a singular cartridge filter 82, other embodiments of the cartridge holder 80 may alternatively feature two male bayonet connectors 86 for respective coupling of two cartridge filters 82 to the cartridge holder 80. Depending on the size of the cartridge filter 82, the position of the male bayonet connector 86 on the disk 84, and the size of the holding collar 12, the cartridge filter(s) may optionally be mountable to the cartridge holder 80 prior to insertion thereof into the holding collar 12 if the relative dimensions allow. In the illustrated example, where the extremes of the cartridge filter 82 project beyond the outer perimeter of the disk 84 when coupled thereto, such pre-mounting of the cartridge filter 82 to the cartridge holder 80 may prevent proper nested receipt of the cartridge holder in the holding collar, and thus may require insertion of the cartridge holder 80 into the holding collar 12 before the cartridge filter 82 can be connected.

Through the combination of the filter pad holder, facemask holders and cartridge holder, the system enables users to effectively assemble and operate a working PAPR fan unit so long as there is an available supply of at least one of the different holder-compatible types of air filtration device: pad filters, disposable facemasks, and cartridge filters. An unexpected inventory shortage or supply chain disruption of any particular subset of these various air filtration devices thus would not prevent use of a PAPR in the presence of the interchangeable holders and at least one available type of those air filtration devices.

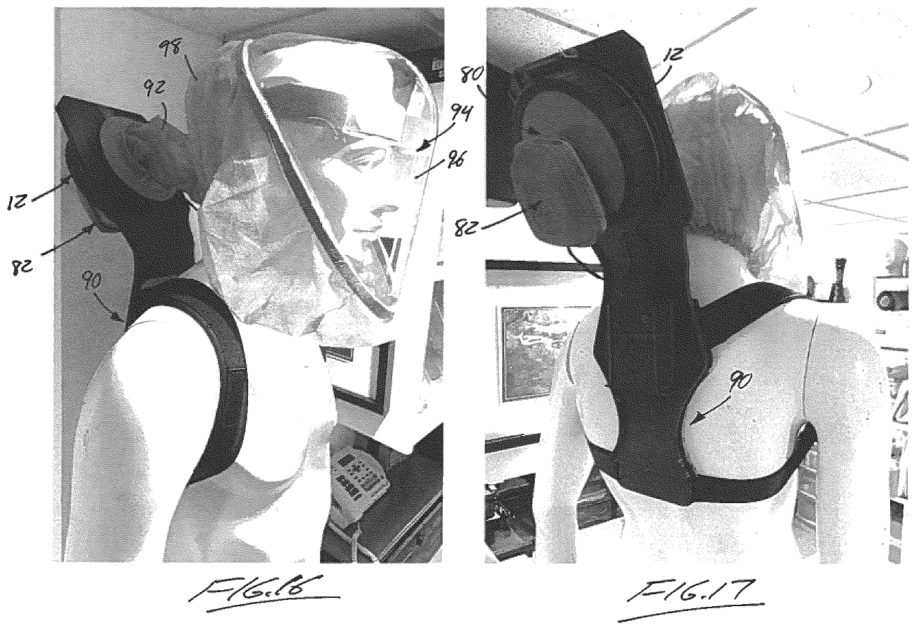

FIGS. 16 and 17 illustrate one possible implementation of the adaptable PAPR fan unit, where the fan support frame 10 is carried by a shoulder harness 90 in a position residing posteriorly of the wearer's back, with the base plate 24 in an upright orientation with the collar support wall 16 projecting rearwardly away from the wearer. A flexible duct 92 has one end secured over the outlet opening of the PAPR fan unit at a front side thereof that faces the wearer, and the other end feeding into a head-enclosing hood 94 composed of a transparent shield 96 and attached flexible shroud 98. FIGS. 16 and 17 show the cartridge holder 80 installed on the PAPR fan unit to enable use of a cartridge filter 82 as the intake filtration means of the PAPR, for which any of the above-described filter pads or disposable facemasks may be substituted by interchange of the cartridge filter holder 80 for the pad holder 52 or any of a number of possible facemask holders 58, 58′.

It will be appreciated that while the illustrated embodiment uses a fan support frame 10 into which a separate axial fan 14 is insertable in a position surrounded by a round collar support wall 16 to which a round holding collar 12 is selectively mountable in a position clamping a selected filter holder and respective filter type in place over a round intake opening of an axial fan 14, it will be appreciated that similar interchangeability of different filter holders enabling adaptive use of different air filtration devices of varying type and/or shape may be put into practice to whether a round holding collar on a round support wall surrounding the intake opening is particularly used to clamp the filter holders in place, whether the holding collar or its equivalent and the filter holder are mounted to a fan support frame or directly to the fan itself, and whether the fan is an axial fan or other fan type (e.g. centrifugal blower).

For example, FIG. 18 shows a variant of the PAPR fan unit and filter pad assembly of FIGS. 5 and 6. In this variant, the PAPR fan unit features a differently styled support frame 10′ that forms a cylindrical enclosure 10A that houses a centrifugal fan instead of an axial fan, and accordingly has a tangentially oriented output port 10B that embodies the air outlet opening 26′ through which the filtered air is blown by the fan. The annular collar support wall 16′ in this variant resides in concentric relation to the cylindrical enclosure 10A at one end thereof, and once again delimits the air intake opening through which air is drawn into the fan during operation thereof. In this variant, the pad holder 52′ is not a two-piece pad holder, nor does it cooperate with a universal holding collar 12 that is also used by the other filter holder types. Instead, the pad holder 52′ is a single-piece pad holder composed of an integral holding collar 12′ that that embodies all the aforementioned features of the universal holding collar 12, but also includes a cross-bar 52A spanning diametrically across the otherwise open circular area delimited by the holding collar's in-turned flange 42. This cross-bar 52A functionally replaces the perforated front cover 54 of the earlier pad holder by partially shielding the otherwise exposed filter pad 50′, and also serves as a user-graspable handle for performing the slide-and-turn bayonet-style coupling of the pad holder's integral holding collar 12′ to the collar support wall 16. For best gripping of the cross-bar 52A, it may have an outwardly bowed or arched profile, as illustrated, so as to protrude outwardly from the plane of its attachment to the in-turned flange 42 of the pad holder's integral holding collar 12′. In place of the cross-bar 52A, the pad holder 52′ may instead feature an integral mesh or web structural spanning the otherwise open center area of the in-turned flange of the pad holder's integral holding collar 12.

Instead of using a perforated rear cover to prevent the filter pad 50′ from being sucked into the fan enclosure, such prevention is instead provided by an inclusion of a set of internal ribs 16D on the collar support wall 16′ that radiate inwardly from the interior surface 16A of the collar support wall at spaced intervals therearound. As shown, these ribs 16D may terminate short of a central intake hole in the end wall of the fan-housing enclosure 10A. The pad holder 52′ is couplable to the collar support wall 16′ via slide-and-turn mating of a set of (for example three) L-shaped slots 46 in the interior surface of it's integral holding collar 12′ with a matching set of (for example three) studs 44 on the collar support wall 16′, just as described earlier in the other PAPR example. This coupling is performed with a filter pad 50′ disposed between the in-turned flange 42 of the pad holder 52′ and the annular edge face 16B′ of the collar support wall 16′, such that the filter pad 50′ is securely clamped therebetween in overlying relationship to the air intake opening bound by this annular edge face 16B′ of the collar support wall 16′. As shown in FIG. 18, the annular edge face 16B′ may have a stepped, rather than purely flat, profile, such that the annular edge face 16B′ is characterized by a slightly raised outer lip that surrounds an unraised inner area of the edge face. In such instance, the filter pad 50 sits atop this unraised inner area, and is therefore surrounded by the raised outer lip. Despite these differences in the design of the support frame 10′ and the filter pad holder 52′, the PAPR fan unit of FIG. 18 remains usable with the same facemask holders 58, 58′ and filter cartridge holder 80 described above in relation to FIGS. 1 to 17, each of which uses the universal holding collar 12 instead of the integral holding collar 12′ of the single-piece pad holder 52′.

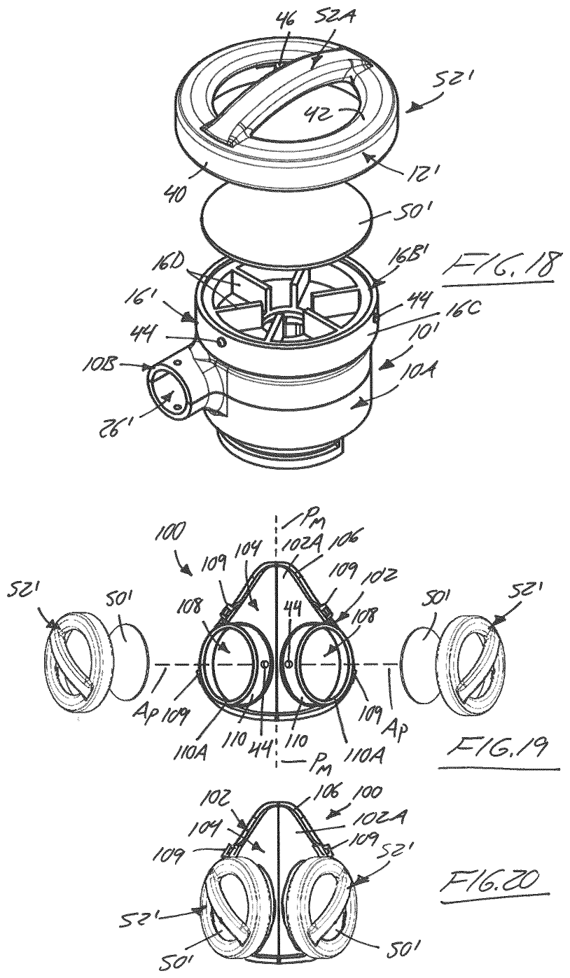

While the foregoing description focusses on filter interchangeability in the context of a power air purifying respirator (PAPR), it will be appreciated that there are other useful applications where similarly interchangeable holders for a variety of differently sized and shaped air filtration devices may be employed. FIGS. 19 through 24 show one such example of another useful application, where instead of the interchangeable filter holders being used on the fan unit of a PAPR, they are instead employed to similar effect one or more inhalation ports of a non-powered reusable orinasal respirator 100. Referring to FIG. 19, in known fashion, the orinasal respirator 100 features an orinasal cup 102 sized and shaped to fit over the mouth and nose of a wearer, with a concave interior of the cup facing the wearer's face and a convex exterior 102A of the cup facing away therefrom. The orinasal cup is composed of one or more impermeable materials, and in the illustrated example comprises a substantially rigid shell 104, and a flexible gasket 106 spanning around a peripheral edge of the rigid shell at an open side thereof in order to make an air tight seal with the wearer's face around the nose and mouth thereof. The shell 104 has a set of connection points 109 defined therearound at spaced intervals around the perimeter of its open side for connection of one or more straps or bands (not shown) to hold the shell in such worn position on the wearer's face.

The rigid shell 104 is penetrated by two inhalation ports 108 residing in symmetric relation to one another across a bisecting midplane P_{M} of the orinasal cup 102, which generally coincides with a median (mid-sagittal) plane of the wearer in a worn position of the orinasal respirator on the wearer's face. The orinasal cup is symmetrical in shape across this bisecting midplane P_{M}, and has an upwardly tapered shape that is wider at the bottom end of the cup 102, which is worn over the wearer's mouth, and narrower at top end of the cup 102, which is worn over a bridge of the wearer's nose. The two inhalation ports 108 lie on respective port axes A_{P} that obliquely intersect the bisecting midplane P_{M} at a common point. Each inhalation port 108 is surrounded by a cylindrical boundary wall 110 that protrudes integrally from the exterior of the rigid shell 104 in concentric relationship around the port's central port axis A_{P}. For each inhalation port 108, the open outer end of the boundary wall 110 furthest from the interior of the orinasal respirator denotes a respective air intake opening of the orinasal respirator 100, though which air is drawn into interior space of the orinasal respirator when a wearing user thereof inhales.

The interchangeable filter system of this embodiment enables equipping of either inhalation port 108 of the orinasal respirator 100 with any selected one of a number of different user-selectable air filtration devices. In the illustrated but non-limiting example, these user-selectable air filtrations devices include pad filters, and two different styles of disposable facemasks. This embodiment differs form the earlier PAPR examples mainly in that the support frame that receives the interchangeable filter holders is not embodied in a PAPR fan unit with one air intake opening, but instead is embodied by the port-equipped shell 104 of the orinasal respirator, with its two inhalation ports and their two respective air intake openings. In another example, instead of an impermeable flexible gasket lining the perimeter of a substantially rigid shell that has integrally formed port boundary walls of sufficiently rigidity to accept coupling of other components thereto, the orinasal cup may be embodied by a larger body of impermeable flexible material, with substantially rigid inserts inset therein to defined the port boundary walls to which the other componentry is couplable to enable the interchange of different air filtration devices.

With reference to FIGS. 19 and 20, the illustrated orinasal respirator embodiment includes two filter pad holders 52′ of the same type described in relation to FIG. 18, but provided in duplicate so that there is one for each inhalation port 108. For mating with the slots 46 at the interior surface of the integral holding collar 12′ of either filter pad holder 52′, the boundary wall 110 of each inhalation port 108 has a matching set of studs 44 thereon for the same slide-and-turn coupling described earlier. Accordingly, each filter pad holder 52′ is operable to clamp a respective filter pad 50′ against the annular edge face 110A of the boundary wall 110 of a respective inhalation port 108 of the orinasal respirator 100 so as to overly the air intake opening of that inhalation port 108 and filter the incoming ambient air drawn therethrough by the wearer's inhalation.

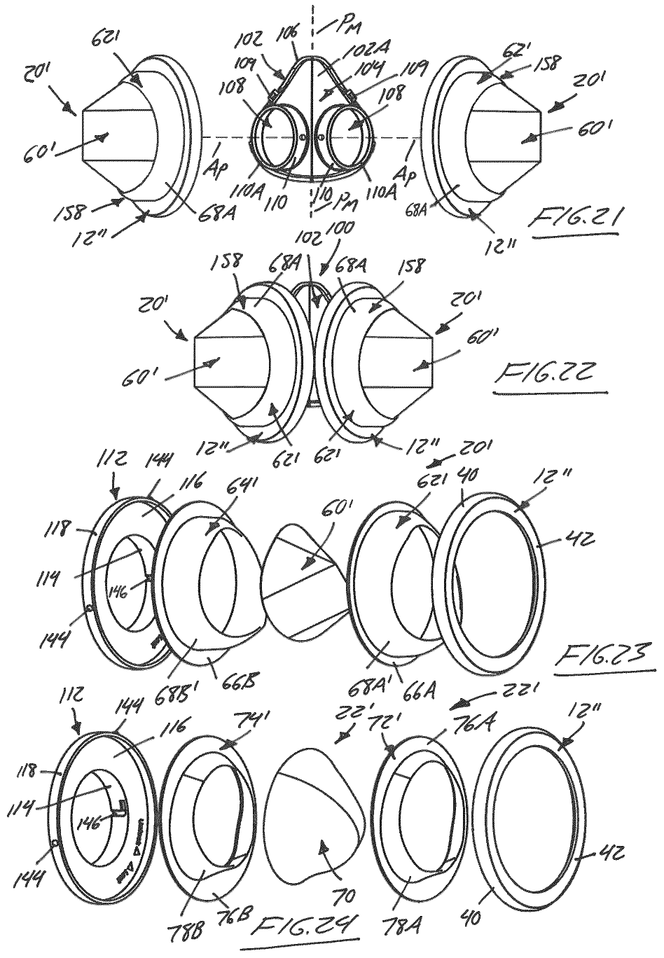

FIGS. 21 and 22 illustrate possible replacement of the two filter pad assemblies with a pair of facemask assemblies 20′ that each include a facemask holder 158 and a tent-like disposable facemask 60′ (e.g. N95 or KN95). Like the earlier facemask holder 58, the present facemask holder 158 is compatible with a foldable/collapsible tent-like disposable facemask 60′ like that of FIGS. 7 through 10, but differing somewhat in shape, in that the open rear side of the tent-like facemask in the present example is more ovaloid than circular, and the width of the mask tapers away from the open end to form a narrower peak at the closed front end of the mask. The facemask holder 158 in this example once again uses two gaskets 62′, 64′, but whose upturned inner rims 68A′, 68B′ are of ovaloid, rather than circular, in profile, compared to the earlier facemask holder 58. Using these two gaskets 62′, 64′ a filter assembly once again features clamped capture of a peripheral edge region of the disposable facemask 60′ between the upturned inner rims 68A′, 68B′ of the two gaskets 62, 64, just like in the earlier PAPR example. Either form of tent-like facemask 60, 60′ (either circular or ovaloid at its open end, and either tapered or more cylindrical in shape) can be used in either the PAPR or orinasal respirator example, given the appropriately shaped set of gaskets.

In the present orinasal respirator embodiment, the port boundary wall 110 of each inhalation port 108, onto which the pad filter assembly is directly installable, is too small in diameter to directly accommodate receipt of the planar outer rims 66A, 66B of the gaskets 62, 64 at the annular edge face 110A of the inhalation port's boundary wall. To rectify this, the illustrated example of the orinasal respirator embodiment includes a pair of sizing adapters, each taking the form of an extension flange 112 that is matable externally to the boundary wall 110 of either inhalation port 108 to increase the effective outer diameter thereof, effectively enlarging the diameter of the port's air intake opening. This effective expansion of the port's intake size enables clamped receipt of the planar outer rims 66A, 66B of the gaskets 62, 64 against this extension flange 112 beneath a cooperatively sized holding collar 12″ of greater diameter that the smaller filter pad holder 52′.

So whereas the first PAPR example in FIGS. 1 to 17 used the same universal holding collar 12 for all of the various filter holders, the illustrated orinasal respirator embodiment instead uses a smaller pad-specific holding collar 12′ for the pad filter holder, optionally embodied as an integral part of a single-piece pad holder 52′ like that of FIG. 18, and uses a different larger holding collar 12″ for the facemask filter holders, which also require use of the sizing adapter extension flange 112 at each inhalation port 108 where such a facemask filter holder is being used. Alternatively, the inhalation ports 108 of the orinasal respirator 100 may be reconfigured with an enlarged boundary wall diameter or radially protruding end flange around the intake opening so as to use larger pad filters that can be held in place using the same large holding collar 12″ as the facemask holders.

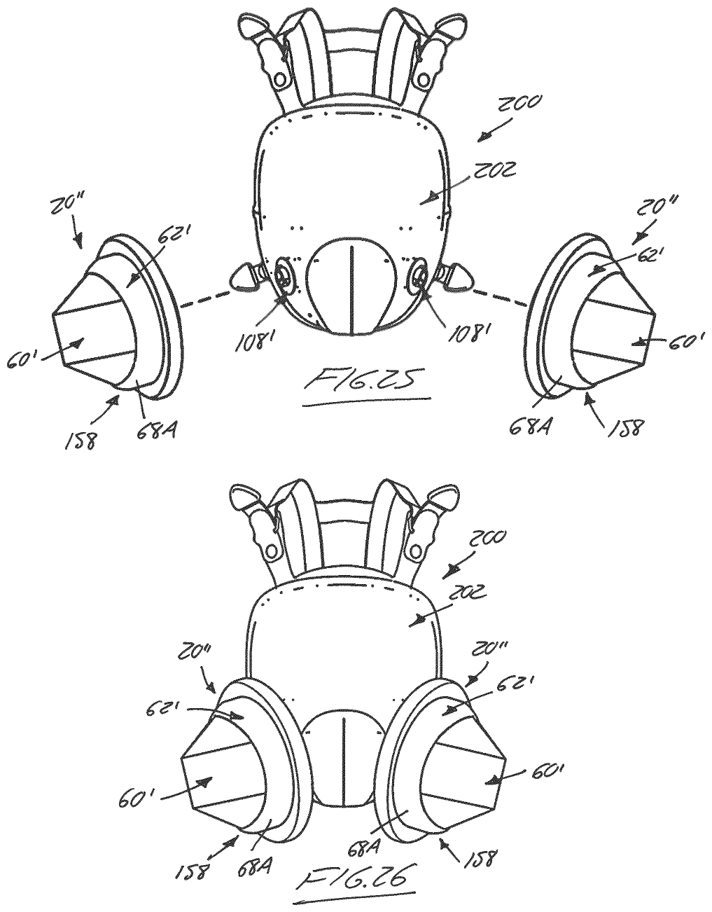

For mating with the studs 44 on the inhalation port boundary walls 110, each extension flange 112 has a matching set of (for example, three) L-shaped slots 146 in the interior surface of an inside cylindrical wall 114 of the extension flange 112, of which one such slot is visible in each of FIGS. 23 and 24. At an outer circumference of each extension flange 112, another set of (for example three) externally protruding studs 144 are situated thereon at discretely and evenly spaced positions around the outside of the extension flange 112, for mating with the set of L-shaped slots 46 provided in the interior surface of the holding collar's cylindrical wall 40 (as already described and illustrated in the earlier PAPR embodiment). Accordingly, the holding collar 12″ is matable to the extension flange 112 to clamp the planar outer rims 66A, 66B of the facemask holder gaskets 62′, 64′ firmly between the holding collar's in-turned flange 42 and an annular face 116 of the extension flange. This annular face 116 of the extension flange 112 spans from the inside cylindrical wall 114 to a circumferential outside wall 118 of the extension flange 112, from whose exterior surface the aforementioned studs 144 protrude. So, when the extension flange 112 is installed on an inhalation port's boundary wall 110 via slide-and-turn coupling of the extension flange's interior slots 146 with the port wall's exterior studs 44, the annular face 116 of the extension flange 112 surrounds the port's boundary wall 110 to increase the effective diameter thereof to accommodate clamped securement of the gasketed facemask by the holding collar 12″, thereby securing the facemask 60′ over the air intake opening of the inhalation port 108 to filter the incoming ambient air drawn therethrough by the wearer's inhalation.

FIG. 24 shows another facemask assembly 22′ that uses the same holding collar 12″ and extension flange 112 as the facemask assembly 20′ of FIG. 23, but whose front and rear gaskets 72′, 74′ have upturned inner rims 78A, 78B of teardrop-shaped profile like those of FIGS. 11 to 13 for use with the same teardrop-style masks 70 thereas, but in the orinasal respirator context of FIGS. 19 to 22, where either one of two such facemask assemblies 22′ is substitutable for either one of the two other facemask assemblies 20′ of FIGS. 21 and 22, or for either one of the two filter pad assemblies of FIGS. 19 and 20. Facemask assembly 22′ employs the same sizing adapter extension flange 112 and holding collar 12″ as facemask assembly 20′.

Finally, FIGS. 25 and 26 illustrate how interchangeable facemask filter assemblies 20″ of the same or similar configuration to the interchangeable facemask filter assemblies 20′, 22′ used on the orinasal respirator 100 in preceding FIGS. 19 to 22 may be similarly used on a full-face respirator 200. Here, rather than residing in an orinasal cup that covers only the mouth and nose area of a wearer's face, the filter-accepting inhalation ports 108′ at which the interchangeable filter holders are interchangeably installable are instead located in a face shield 202 that covers a substantial entirety of the wearer's face. FIG. 25 demonstrates how the inhalation ports 108′ may be notably smaller in some instances, whether in the context of orinasal respirators or full-face respirators, compared to the relatively large inhalation ports shown in FIGS. 19 and 21, where the illustrated orinasal respirator is designed to use pad filters as the default air filtration device when available. In other instances, a respirator may be designed to use cartridge filters with smaller bayonet connectors as the default air filtration device, in which case the studded bayonet-capable boundary walls of the inhalation ports are likewise relatively small, as illustrated in FIG. 25. The sizing adapter extension flange 112 of FIGS. 23 and 24 can be easily modified for such applications, simply by reducing the inside diameter of the extension flange to properly fit with the smaller inhalation ports of the respirator 200. In such cases where cartridge filters are the default, the same large extension flange 112 used for the facemask holders may be used for similar purpose with large filter pads, either with the same large holding collars 12″ and a separate perforated front cover 54 like that of the first PAPR embodiment, or with a larger version of the single-piece pad holder 52′.

It will be appreciated that while the various embodiments contemplated above each include bayonet-style couplings with matable studs and slots for slide-and-turn coupling, threaded couplings may alternative be employed in place thereof. It will also be appreciated that the single-piece pad holder 52′ illustrated in the context of the orinasal and full-face respirator embodiments may be substituted for a multi-piece pad holder that has a fully open-centered holding collar and a separate perforated front cover insertable into the holding collar in front of the filter pad, and optionally accompanied by a perforated rear cover insertable behind the filter pad, as described in the PAPR context of the first embodiment.

In each and every embodiment detailed above, the air filtration device itself, if anything, is preferably the only disposable component, while the filter holder and the holding collar (whether separate components of a multi-piece holder, or integral components of a single-piece holder) are intended for reuse, and are made of impermeable and washable, and preferably sterilizable, material to enable reuse thereof with a new air filtration device when the current one has reached the end of its useful life. The holder, and holding collar if separate therefrom, are thus separate components from the air filtration device, and are used to releasably hold the separate air filtration device in a manner enabling removal of the air filtration device in a manner non-destructive and non-detrimental to the holder and holding collar.

It will also be appreciated that in the foregoing description, the descriptor “disposable” in the expression “disposable facemask”, is used to differentiate those facemasks (e.g. N95 or KN95 facemasks) from the face-worn, and thus also “mask-like”, orinasal and full-face respirators 100, 200, which are intended as “reusable” products, where the air filtration medium is not an integral or otherwise affixed “permanent” part of the mask-like respirator itself. The term disposable is therefore not limited to a “one-time-use” facemask or other air filtration product, and may encompass a “limited time use” product that maybe reused for a limited lifespan (worn hours, number of wears, etc.). As opposed to the disposable vs. reusable characterization, another or alternative distinction between the face-worn respirators 100, 200 and the facemasks usable thereon via the interchangeable facemask holder is that the main body of the facemask, the part that would conventionally be worn directly over the mouth and nose, and is materially distinct from any accompanying secondary adornment/fitment components used to adorn/fit that face-covering body to the wearers face (nose clip, securement band/strap, etc.), it itself the air filtration component of the mask, for example having a fibrous composition that is air permeable and embodies the air filtration medium of the facemask. This is distinguished from the orinasal respirator 100 and full-face respirator 200, where the face-covering main body of the respirator (e.g. the orinasal cup 102 of the orinasal respirator, or the face shield 202 of the full-face respirator) has a non-fibrous, impermeable composition that is incapable of allowing airflow therethrough, thus performs no air filtration function itself, and instead relies on a separate air filtration component to embody the air filtration medium of the respirator.

Since various modifications can be made in my invention as herein above described, and many apparently widely different embodiments of same made, it is intended that all matter contained in the accompanying specification shall be interpreted as illustrative only and not in a limiting sense.

1. An interchangeable filter system for a respirator, said system comprising a support frame, an air intake opening therein, a plurality of interchangeable filter holders each configured for selective mounting thereof to the support frame, and each configured to receive and hold a different respective type of air filtration device in a working position of operable relationship to said air intake opening to filter incoming ambient air, whereby the plurality of interchangeable filter holders enable customization of the system according to available on-hand inventory of one of more different types of air filtration devices.

2. The system of claim 1 wherein said plurality of interchangeable filter holders include at least one facemask holder configured to receive and hold an air filtration facemask in operable relation to the air intake opening.

3. The system of claim 2 wherein said at least one facemask holder comprises multiple facemask holders, each configured to receive and hold a differently shaped facemask.

4. The system of claim 2 wherein each facemask holder is of annular form and has a center opening therein whose shape profile conforms to an outer shape profile of a facemask at a peripheral edge region thereof.

5. The system of claim 2 wherein each facemask holder comprises a pair of gaskets shaped for receipt of a facemask's peripheral edge between said pair of gaskets.

6. The system of claim 5 wherein said pair of gaskets are hinged together in clamshell fashion for movement between an open position enabling placement of the facemasks' peripheral edge between said gaskets, and a closed position sealing the facemask's peripheral edge between said gaskets.

7. The system of claim 1 wherein said plurality of interchangeable filter holders include a cartridge holder configured to receive and hold a cartridge filter in operable relation to the air intake opening.

8. The system of claim 7 wherein said cartridge holder comprises a male bayonet connector thereon for mating with a female bayonet connector of said cartridge filter.

9. The system of claim 1 wherein said plurality of interchangeable filter holders includes a pad holder composed of at least one perforated cover for overlying a respective face of a filter pad.

10. (canceled)

11. The system of claim 1 comprising an addition holding component matable with the support frame and compatible with at least a subset of the interchangeable filter holders to hold a selected one thereof in place when mated to the support frame.

12. The system of claim 11 wherein the holding component comprises a holding collar matable with a collar support wall found on the support frame in surrounding relation to the air intake opening.

13. The system of claim 1 further comprising a holding collar configured for selective mating thereof with a collar support on the support frame that spans around the air intake opening, in a position operable to hold one of said filter holders in place between the holding collar and the collar support when mated together.

14. The system of claim 13 wherein said holding collar has bayonet coupling features thereon for bayonet-like slide-and-turn connection of the holding collar to the collar support.

15. The system of claim 13 further comprising a coupling confirmation indicator configured for automatic activation thereof upon proper and full mating of the holding collar on the collar support.

16. The system of claim 15 wherein said coupling confirmation indicator comprises an indicator light configured to illuminate upon said proper and full mating of the holding collar on the collar support.

17. The system of claim 1 further comprising a confirmation indicator configured for automatic activation thereof upon full and proper securement of any one of said filter holders to the support frame.

18. The system of claim 17 wherein said coupling confirmation indicator comprises an indicator light configured to illuminate upon said full and proper securement of any one of said filter holders to the support frame.

19. The system of claim 1 wherein said support frame and air intake opening are embodied in a fan unit of a powered air purifying respirator that comprises a fan operable to draw air through said intake opening and convey said air onwardly to a headspace of said powered air purifying respirator, whereby the plurality of interchangeable filter holders enable customization of the fan unit according to available on-hand inventory of one of more different types of air filtration devices.

20. The system of claim 1 wherein the support frame is embodied in a reusable face-worn respirator having at least one inhalation port therein at which the plurality of interchangeable filter holders are selectively and interchangeably couplable to the reusable face-worn respirator.

21. (canceled)

22. The system of claim 1 wherein the plurality of interchangeable filter holders includes differently sized filter holders, including a smaller filter holder matable directly to a feature of the support frame to secure a smaller air filtration device in place, and at least one larger filter holder of non-matable relation to said feature of the support frame and requiring an intermediary sizing adapter to secure a larger air filtration device in place.

23. The system of claim 22 wherein said intermediary sizing adapter comprises an extension flange matable to said feature of the support frame to effectively enlarge the air intake opening and thereby accommodate the at least one larger filter holder.

24. The system of claim 23 wherein the at least one larger filter holder comprises a plurality of larger filter holders, and said extension flange is a shared extension flange compatible with each of said plurality of larger filter holders.

25. The system of claim 23 comprising a large holding collar configured for selective mating thereof with the extension flange, wherein the at least one larger filter holder is configured to be held in place between the large holding collar and the extension flange when mated together.

26. A respirator comprising:
a support frame, an air intake opening therein, and a collar support of surrounding relationship to said air intake opening;
a holding collar configured for selective installation thereof on the collar support; and
at least one filter holder configured for held securement by said holding collar when installed on the collar support, and said filter holder also being configured to, in-turn, hold an air filtration device in a working position of operable relationship to said air intake opening to filter incoming ambient air.

27. The respirator of claim 26 wherein said respirator is a powered air purifying respirator having a fan unit that embodies the support frame and the air intake opening, and that comprises a fan operable to draw air through said intake opening and convey said air onwardly to a headspace fed by said powered air purifying respirator.

28. The respirator of claim 26 wherein the respirator is a reusable face-worn respirator having an inhalation port therein at which the air intake opening is embodied.

29. The respirator of claim 26 comprising an extension flange detachably matable with the inhalation port at an exterior of the face-worn respirator to effectively enlarge an air intake area of the inhalation port.

30. A respirator comprising:
a support frame having an air intake opening; and
at least one filter holder that:
is configured for selective mounting thereof to the support frame in a manner modifying an effective profile of the air intake opening; and
is also configured to hold a separate air filtration device of conforming size and shape to the modified effective profile of the air intake opening.

31. The respirator of claim 30 wherein said respirator is a powered air purifying respirator having a fan unit that embodies the support frame and the air intake opening, and that comprises a fan operable to draw air through said intake opening and convey said air onwardly to a headspace fed by said powered air purifying respirator.

32. The respirator of claim 30 wherein the respirator is a reusable face-worn respirator having an inhalation port therein at which the air intake opening is embodied.

33-41. (canceled)
